(19) United States
(12) Patent Application Publication
(10) Pub. No.: US 2009/0041488 A1
(43) Pub. Date: Feb. 12, 2009

(54) IMAGE FORMING APPARATUS AND CONTROL METHOD THEREOF

(75) Inventor: Jong-min LEE, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/139,684

(22) Filed: Jun. 16, 2008

(30) Foreign Application Priority Data
Aug. 11, 2007 (KR) 2007-80975

(51) Int. Cl. G03G 15/043

(52) U.S. Cl. 399/51

(57) ABSTRACT

An image forming apparatus includes a light emitting unit that emits light based on image data, an image forming unit that forms an image by scanning the light emitted from the light emitting unit, a sensing unit that senses a light quantity of the light emitted from the light emitting unit, and a controller that adjusts the image data to make the sensed light quantity reach a predetermined target light quantity and applies the adjusted image data to the light emitting unit.

### CROSS-REFERENCE TO RELATED APPLICATIONS

This application claims priority under 35 U.S.C. §119(a), from Korean Patent Application No. 10-2007-0080975, filed on Aug. 11, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus and a control method thereof, and more particularly, to an image forming apparatus that scans with light from a light scanning unit and a control method thereof.

2. Description of the Related Art

A general light scanning unit used in an image forming apparatus, such as a digital copy machine, a laser printer, a facsimile, etc., includes a laser diode (LD) for scanning a laser beam through a polygon mirror and forming an image on an exposure object.

Referring to FIG. 1A, the general light scanning unit includes a light source 1 to generate and scan a beam, a beam deflector 7 having a mirror 7a to deflect the beam from the light source 1 to be main-scanned to an exposure object 15, and an f-θ lens 11 to correct an optical error of the deflected beam on the exposure object 15. Between the light source 1 and the beam deflector 7 are further provided a collimating lens 3 for collimating the beam and a cylinder lens 5 for shaping the collimated beam.

The light scanning unit employing a laser diode as the light source 1 has to keep light intensity constant to form a uniform image pattern, so that an auto power control (APC) circuit is needed to control light emission of the laser diode.

As illustrated in FIG. 1B, the conventional image forming apparatus includes a circuit 13 which sets up a target quantity of light to be scanned from the light scanning unit with respect to desired intensity of an output image, monitors the light emitted from the light source 11, and regulates a variable resistor 12 separately provided in the light scanning unit while manufacturing the light scanning unit, thereby allowing the light source 11 to emit light corresponding to the target light quantity. As the variable resistor 12 is regulated, there is a difference in the light quantity according to manufacturing errors. To address such errors, a separate manufacturing process is required in addition to the light quantity adjusting process.

Particularly, a multi-beam laser separately needs as many variable resistors as the number of beams, so that they take up too much of a limited space of the light scanning unit and increase a product cost. Further, if the plural laser diodes are different in the light quantity, image quality may be lowered and it is inconvenient to regulate them one by one.

### SUMMARY OF THE INVENTION

The present general inventive concept provides an image forming apparatus that automatically adjusts light quantity from a light emitting unit to increase convenience in production and minimize an error on a manufacturing process, and a control method thereof.

The present general inventive concept also provides an image forming apparatus that minimizes difference in light quantity among plural light sources to enhance image quality, and a control method thereof.

Additional aspects and utilities of the present general inventive concept will be set forth in part in the description which follows and, in part, will be obvious from the description, or may be learned by practice of the present general inventive concept.

The foregoing and/or other aspects of the present general inventive concept can be achieved by providing an image forming apparatus including a light emitting unit to emit light based on image data, an image forming unit to form an image by scanning the light emitted from the light emitting unit, a sensing unit to sense a quantity of the light emitted from the light emitting unit, and a controller to adjust the image data such that the sensed light quantity is substantially equal to a predetermined target light quantity and the adjusted image data is applied to the light emitting unit.

The light emitting unit may be plural in number corresponding to colors of the image data.

The controller may adjust the image data such that an error between the sensed light quantity and the target light quantity is substantially equal to zero.

The sensing unit may generate an electric current based on light received from the light emitting unit, and may detect a synchronous signal to allow the light emitting unit to emit light.

The controller may include an A/D converter to convert the light quantity sensed by the sensing unit into a digital value, and a D/A converter to apply an electric current to the light emitting unit corresponding to image data such that the light emitting unit emits light having substantially the target light quantity.

The sensing unit may sense the light quantity through a resistor having a fixed value.

The foregoing and/or other aspects of the present general inventive concept can also be achieved by providing a method of controlling an image forming apparatus, the method including emitting a quantity of light from a light emitting unit corresponding to image data, sensing a quantity of light emitted from the light emitting unit, and controlling the image data such that the sensed quantity of light is substantially equal to the predetermined target light quantity and inputting the adjusted image data to the light emitting unit.

The method of controlling the image forming apparatus may further include comparing the sensed quantity of light to the predetermined target light quantity and adjusting the image data based on the comparison.

The light emitting unit may be plural in number corresponding to colors of the image data, where colors of the image data correspond to first color image data and second color image data.

The controlling of the image data of the light emitting unit may include controlling an error between the sensed light quantity and the target light quantity to be substantially equal to zero.

The sensing the light quantity of the light emitting unit may include generating an electric current to drive the light emitting unit based on quantity of light sensed from the light emitting unit.

The controlling of the image data such that the sensed quantity of light is substantially equal to the predetermined target light quantity and may include performing an analog-to-digital (A/D) conversion to convert the sensed quantity of light into a digital value, and performing digital-to-analog (D/A) conversion of an adjusted error signal to apply an electric current corresponding to image data to drive the light emitting unit to emit light having a value substantially equal to the predetermined target light quantity.

The sensing the quantity of light of the light emitting unit may include sensing a quantity of light emitted by the light emitting unit using a resistor having a fixed value.

The foregoing and/or other aspects of the present general inventive concept can also be achieved by providing a light quantity control system usable with an image forming apparatus, including a light emitting unit to emit light corresponding to image data, a sensing unit to sense the light emitted from the light emitting unit, and a controller to adjust the image data according to the sensed value of light such that the light emitting unit emits light according to the adjusted image data.

The light quantity control system may also include a calculating device to calculate a difference between the sensed light and a target light value, where the controller may adjust the image data according to the calculated difference.

The light quantity control system may also include an error reduction unit to reduce a difference in value between a value of light detected from the light emitting unit and an image data target light value such that the reduced difference in value is substantially equal to zero, and having an output equal to the reduced difference in value, where the controller may adjust the image data according to the reduced difference.

The image data may include first color image data and second color image data, the controller may adjust the first color image data and the second color image data, and the light emitting unit may emit first light and second light according to the adjusted first color image data and the adjusted second color image data, respectively.

The light emitting unit may include a laser diode to emit light corresponding to the image data, a photodiode to sense the emitted light, and a feedback loop to control the light emitting unit to emit light according to the sensed light, the sensing unit may sense the light emitted according to the sensed light of the photodiode of the light emitting unit, and the controller may control the light emitting unit to emit the light according to the sensed light.

The foregoing and/or other aspects of the present general inventive concept can also be achieved by providing a method to control a light quantity control system usable with an image forming apparatus, the method including emitting light from a light emitting unit corresponding to image data, sensing the emitted light, and controlling the image data to adjust the image data according to the sensed light such that the light emitting unit emits light according to the adjusted image data.

The method may also include calculating a difference between the sensed light and a target light value, where the controlling the image data may include adjusting the image data according to the calculated difference.

The method may further include reducing a difference in value between a value of light detected from the light emitting unit and an image data target light value such that the reduced difference in value is substantially equal to zero, and providing an output signal equal to the reduced difference in value, where the controlling the image data may include adjusting the image data according to the reduced difference.

The image data may include first color image data and second color image data, the controlling the image data may include adjusting the first color image data and the second color image data, and the emitting the light may include emitting first light and second light according to the adjusted first color image data and the adjusted second color image data, respectively.

The light emitting unit may include a laser diode to emit light corresponding to the image data, a photodiode to sense the emitted light, and a feedback loop to control the light emitting unit to emit light according to the sensed light, the sensing the emitted light may include sensing the emitting light according to the sensed light of the photodiode of the light emitting unit, and the controlling the image data may include controlling the light emitting unit to emit the light according to the sensed light.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings, of which:

FIG. 1A illustrates a general light scanning unit;

FIG. 1B is a circuit diagram of a circuit to illustrate adjusting a light quantity of the general light scanning unit of FIG. 1A;

FIG. 2 is a control block diagram of an image forming apparatus according to an exemplary embodiment of the present general inventive concept;

FIG. 3A illustrates a configuration of an image forming apparatus according to an exemplary embodiment of the present general inventive concept;

FIG. 3B is a circuit diagram of a circuit to adjust an emitted light quantity of a light emitting unit according to an exemplary embodiment of the present general inventive concept; and

FIG. 4 is a control flowchart of the image forming apparatus according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

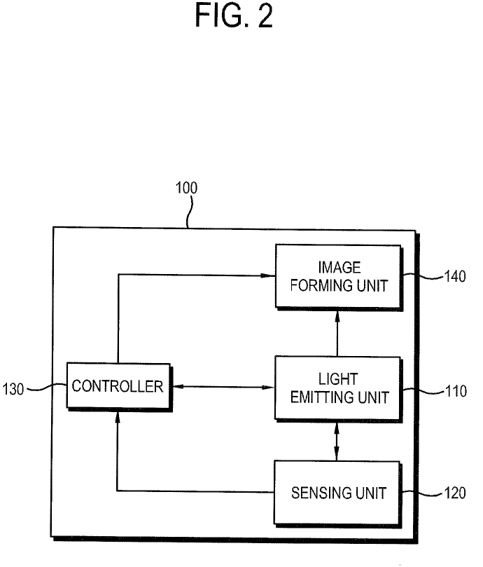

As illustrated in FIG. 2, an image forming apparatus 100, according to an exemplary embodiment of the present general inventive concept, includes a light emitting unit 110, a sensing unit 120, a controller 130, and an image forming unit 140.

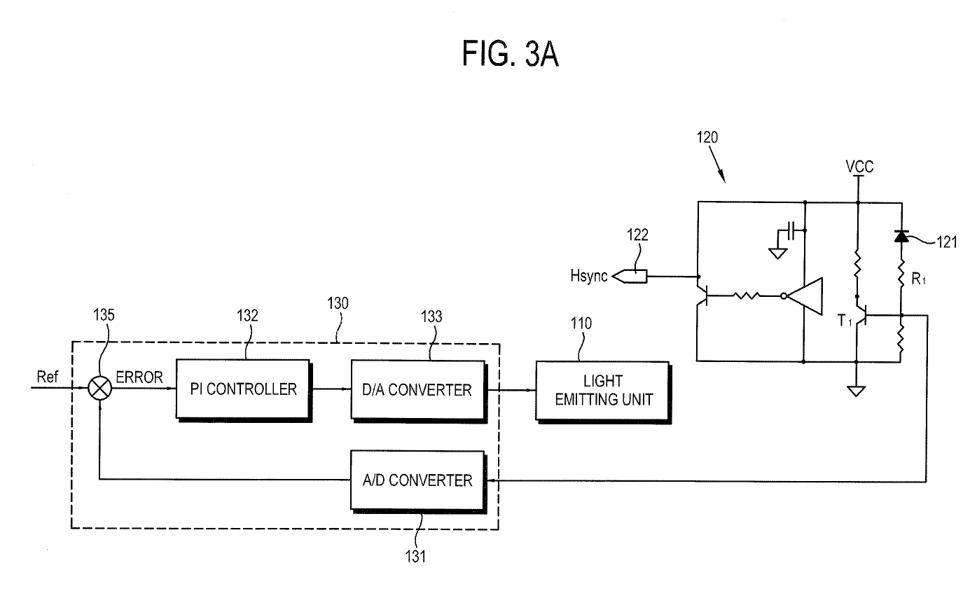

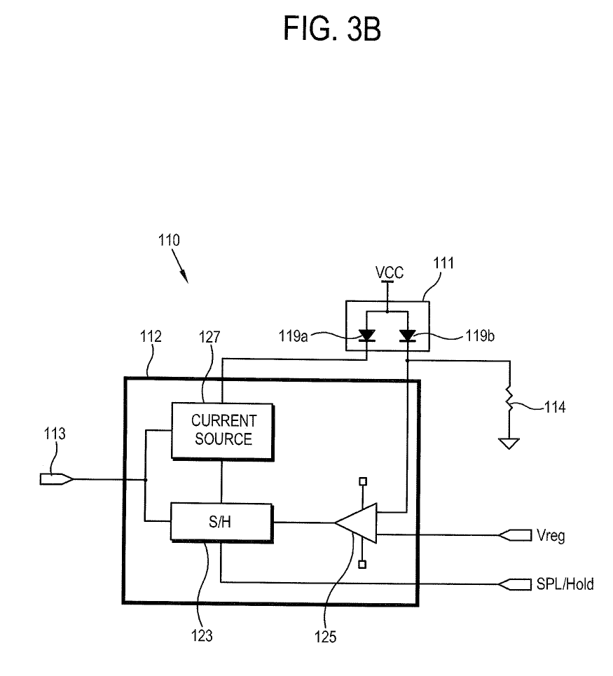

The light emitting unit 110 receives predetermined image data from the controller 130 and emits light corresponding to the received predetermined image data. Referring to FIG. 3A, in an embodiment, the light emitting unit 110 may be a laser diode module, including a laser diode. The light emitting unit 110 may be plural in number such that a separate light emitting unit 110 may be used for a corresponding color of the image data. For example there may be a separate respective light emitting unit 110 corresponding to black, magenta, cyan and yellow image data.

In this example, the image data may be a test value to test the quantity of light emitted from the laser diode according to specifications of the image forming apparatus 100.

The sensing unit 120 receives the light emitted from the laser diode of the light emitting unit 110. Referring to FIG. 3A, the sensing unit 120 according to the present embodiment may be embodied as a horizontal synchronous signal detector provided in the image forming apparatus, by way of example, and it may be placed outside the light emitting unit 110. The horizontal synchronous signal detector may provide a horizontal sync output signal 122, Hsync, which may be provided as a control signal to a display device (not illustrated).

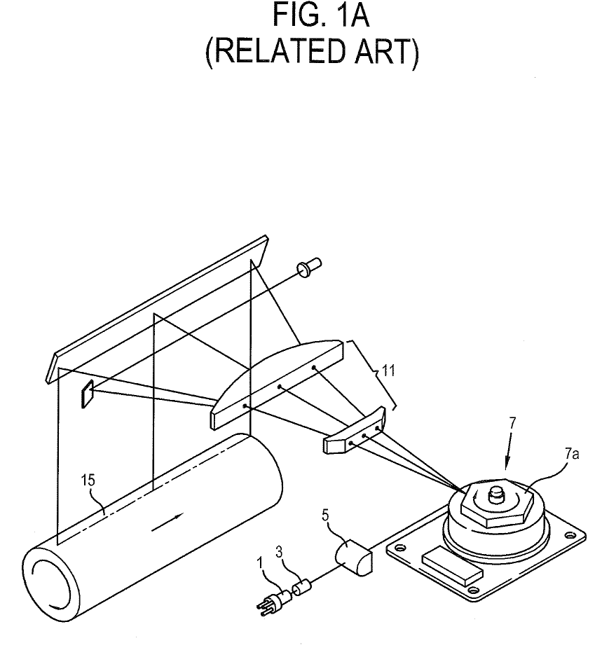

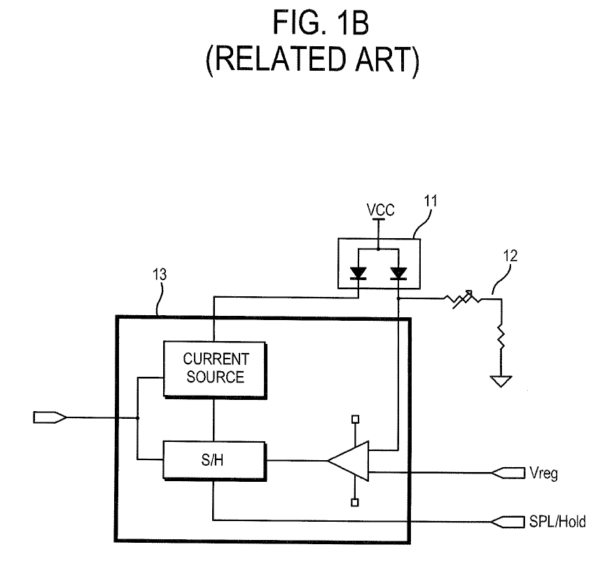

Referring to FIG. 3B, in an embodiment of the general inventive concept, the light emitting unit 110 employs not a variable resistor, as for example, the variable resistor 12 of FIG. 1B, but instead employs a fixed resistor 114 since the light quantity emitted from the light emitting unit 110 is controlled by the controller 130 and not by a variable resistor.

The controller 130 controls the light emitting unit 110 and the image forming unit 140, respectively, to emit light and to scan the light corresponding to the predetermined image data provided by the controller 130 so as to form an image. To adjust the emitted light quantity of the light emitting unit 110, the controller 130 controls the light emitting unit 110 on the basis of a light quantity sensed by the sensing unit 120 when the light emitting unit 110 emits light corresponding to the predetermined data, so that the light emitting unit 110 can emit light having a target light quantity. That is, the controller 130 may function as an error reduction unit to reduce a difference in value between a detected light value of image data detected by the light sensing unit 120, and an image data reference light value, or target light quantity, Ref, such that the reduced difference in value is zero, or substantially equal to zero.

As illustrated in FIG. 3B, light source 111 of the light emitting unit 110 may include a laser diode 119a and/or a photodiode 119b to emit light. When data 113, which may be the predetermined image data from controller 130, is input to an automatic power control (APC) circuit 112, an electric current corresponding to an intensity of an output image is generated by current source 127 and input to the laser diode 119a, and the light source 111 emits light having a light quantity corresponding to the electric current. The APC circuit 112 may also include a sample and hold (S/H) circuit 123 to regulate the current source 127. The S/H circuit 123 may receive a regulating signal as an output of a comparator 125 which compares a regulating voltage, Vreg, to an output of the photodiode 119b of the light source 111. A sample and hold control signal, SPL/Hold, which may be a clock signal, may be provided as an input to synchronize the S/H circuit 123.

Referring to FIG. 2, the sensing unit 120 senses the light quantity of the light emitted from the light source 111, and informs the controller 130 of the sensed light quantity. As discussed above, the sensing unit 120 may be realized as a horizontal synchronous signal detector to generate a horizontal synchronous signal 122 (referring to FIG. 3A) of the light source 111 of the light scanning unit. As illustrated in FIG. 3A, the sensing unit 120 may include a light receiving element 121, e.g., a photodiode, a resistor and a transistor. In an embodiment, the light receiving element 121 is a photodiode which can be implemented as the photodiode 119b of the light source 11 of the light emitting unit 110, that is, the light receiving element 121 and the photodiode 119b would be the same element.

Incident light emitted from the light source 111 is received and photoelectrically converted in the light receiving element 121, and then converted into an analog voltage at point A via the resistor R1 and the transistor T1 of the sensing unit 120. In this example, the analog voltage at point A is applied between a base and an emitter of the transistor T1 to detect a horizontal synchronous signal, which as described above may be output from the sensing unit 120 as the horizontal sync signal 122, Hsync, and the analog voltage may be coded in digital binary form by an analog/digital (A/D) converter 131 provided in the controller 130.

Referring to FIGS. 3A and 3B, the controller 130 may compare the target light quantity, Ref, with the value of the light quantity emitted from the light source 111 and sensed by the sensing unit 120, and may adjust the data 113 (that is, the predetermined image data) to be transmitted to the light source 111, thereby making the emitted light quantity of the light source 111 the same, or substantially the same as, the target light quantity.

According to an exemplary embodiment of the present general inventive concept, as illustrated in FIG. 3A, the controller 130 controls the light emitting unit 110 to emit light having a target light quantity of the light scanning unit which is equal to a reference value Ref, corresponding to the target light quantity, in order to control a desired intensity of the output image. Specifically, the controller 130 recognizes the light quantity output from the light source 111 on the basis of analog voltage levels output from the light receiving element 121 and provided to the controller 130, and adjusts the light quantity to be emitted by the light source 111 to be equal to, or substantially equal to, the target light quantity.

Further, a calculating device 135 of the controller 130, which may be a multiplier, a subtractor, or an adder, calculates a difference between the recognized light quantity received by the light receiving element 121 and the target light quantity, Ref, and inputs a value which represents the calculated difference to a Proportional plus Integral (PI) controller 132 of the controller 130, thereby using a control voltage level in the controller 130 such that the calculated difference is equal to, or substantially equal to, zero, such that the calculated difference corresponds to a voltage level to be output from the digital/analog (D/A) converter 133 and provided to the light emitting unit 110, which may be provided in the light scanning unit of the image forming apparatus 100.

Referring to FIG. 3A, the controller 130 controls the A/D converter 131 to convert into a digital value the analog voltage at point A sensed by the sensing unit 120, and provided to the A/D converter 131. The difference between the target light quantity reference value Ref and the value of the digitized sensed light quantity may be calculated by the calculating device 135, and the calculated difference, which is the error, may be input to the PI controller 132. A control algorithm, which may be used to control the PI controller 132, is activated such that the calculated difference, that is, the error, is equal to, or substantially equal to, zero, and a binary code obtained by the control algorithm is converted into an analog voltage through the D/A converter 133, thereby operating the laser diode 119a of the light source 111 with this analog voltage (DAC voltage). Thus, the light emitting unit 110 is automatically controlled to emit the light quantity corresponding to the target light quantity Ref, in contrast to a known light emitting unit which includes variable resistors which have to be regulated one by one in a manufacturing process.

Below, operations of the PI controller 132 will be described in more detail. A value of a monitoring electric current which is equivalent, or substantially equivalent, to the target light quantity reference value Ref, is input to a reference register (not illustrated). A subtractor obtains an error value by subtracting a feedback real time value, which is a real time value of the light sensed by the light receiving element 121, from the target light quantity reference value Ref. The operation of the PI controller 132 may be defined by the following Equation 1.

y=Kₚ*E+Kᵢ*∫Edt <Equation 1>

The error E obtained by the subtractor is multiplied by a proportional constant Kₚ, and the sum of errors (SE) is multiplied by an integral constant Kᵢ. The proportional term and the integral term are summed to calculate a new voltage level to be used operate the laser diode 119a of the light source 111 of the light emitting unit 110. In this example, the sum of errors (SE) is calculated by “the sum of errors (SE)=E+SE.” Generally, SE[n]=SE[n−1]+E[n], where “n” and “n−1” imply a present step and a previous step, respectively. If the errors are summed three times, the following calculations may be performed.

SE[3]=SE[2]+E[3]

SE[2]=SE[1]+E[2]

SE[1]=SE[0]+E[1]:SE[0]=0

If the proportional constant of the PI controller 132 is a decimal fraction, a stability limit method may be used because digital calculation of the decimal fraction may be difficult. For example, if Kₚ and Kᵢ are the values “0.057” and “0.002” respectively, they are multiplied by the value “1000” under the stability limit method, resulting in Kₚ and Kᵢ being integers having the respective values of “57” and “2.”

Through these processes, the controller 130 may adjust the voltage level output from the D/A converter 133 to be equivalent to, or substantially equivalent to, the target light quantity Ref and may apply the adjusted voltage level as data 113 to the light emitting unit 110.

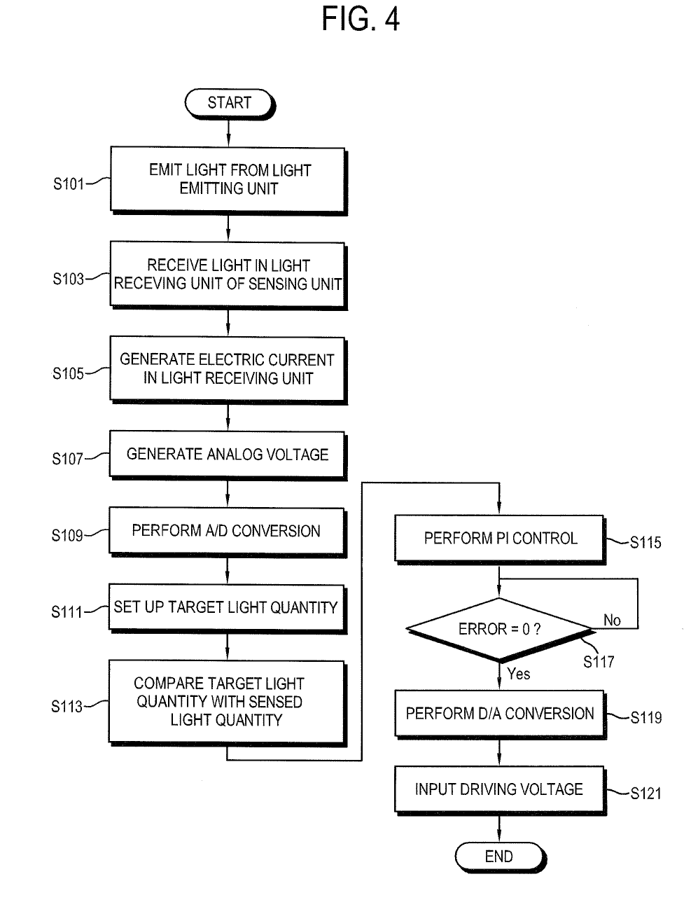

Below, operations of the image forming apparatus 100, according to an exemplary embodiment of the present general inventive concept, will be described with reference to FIG. 4.

At operation S101, the light emitting unit 110 emits light based on predetermined image data input to it by the controller 130. At operation S103, the light receiving element 121 receives some of the emitted light. At operation S105, the light receiving element 121 photoelectrically converts the received light into an electric current.

At operation S107, the circuit of the sensing unit 120 generates an analog voltage corresponding to the received light and provides the analog voltage to the controller 130. At operation S109, the controller 130 controls the A/D converter 131 to convert the analog voltage into a digital value.

At operation S111, the controller 130 determines the target light quantity Ref. At operation S113, the controller 130 compares the target light quantity with the sensed light quantity from the light sensing unit 120, thereby calculating an error value. At operation S115, the error value is input to the PI controller 132. At operation S117, the PI controller 132 is controlled such that the error value is adjusted to be equal to, or substantially equal to, zero. At operation S119, a D/A conversion is applied by the D/A converter 133 to a value obtained from the PI controller 132. At operation S121, the D/A-converted value is applied to the light emitting unit 110 as a voltage to drive the laser diode 119a included therein.

According to an exemplary embodiment of the present general inventive concept, the light quantity of the light emitted from the light emitting unit is automatically adjusted to increase convenience in production and to minimize an error of a manufacturing process.

According to an exemplary embodiment of the present general inventive concept, differences in light quantity among plural light sources are minimized to enhance image quality.

Although a few exemplary embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a light emitting unit to emit light based on image data;
an image forming unit to form an image by scanning light emitted from the light emitting unit;
a sensing unit to sense a quantity of the light emitted from the light emitting unit; and
a controller to adjust the image data such that the sensed light quantity is substantially equal to a predetermined target light quantity and the adjusted image data is applied to the light emitting unit.

2. The image forming apparatus according to claim 1, wherein the light emitting unit is plural in number corresponding to colors of the image data.

3. The image forming apparatus according to claim 1, wherein the controller adjusts the image data such that an error between the sensed light quantity and the target light quantity is substantially equal to zero.

4. The image forming apparatus according to claim 1, wherein the sensing unit generates an electric current based on light received from the light emitting unit, and detects a synchronous signal to allow the light emitting unit to emit light.

5. The image forming apparatus according to claim 4, wherein the controller comprises:
an A/D converter to convert the light quantity sensed by the sensing unit into a digital value; and
a D/A converter to apply an electric current to the light emitting unit corresponding to image data such that the light emitting unit emits light having substantially the target light quantity.

6. The image forming apparatus according to claim 1, wherein the sensing unit senses the light quantity through a resistor having a fixed value.

7. A method of controlling an image forming apparatus, the method comprising:
emitting a quantity of light from a light emitting unit corresponding to image data;
sensing a quantity of light emitted from the light emitting unit; and
controlling the image data such that the sensed quantity of light is substantially equal to a predetermined target light quantity and inputting the controlled image data to the light emitting unit.

8. The method of claim 7, further comprising:
comparing the sensed quantity of light to the predetermined target light quantity and adjusting the image data based on the comparison.

9. The method according to claim 7, wherein the light emitting unit is plural in number corresponding to colors of the image data.

10. The method according to claim 7, wherein the controlling the image data of the light emitting unit comprises:
controlling an error between the sensed light quantity and the target light quantity to be substantially equal to zero.

11. The method according to claim 7, wherein the sensing the light quantity of the light emitting unit comprises:
generating an electric current to drive the light emitting unit based on the quantity of light sensed from the light emitting unit.

12. The method according to claim 11, wherein the controlling the image data such that the sensed quantity of light is substantially equal to the predetermined target light quantity comprises:
performing an analog-to-digital (A/D) conversion to convert the sensed quantity of light into a digital value, and performing a digital-to-analog (D/A) conversion of an adjusted error signal to apply an electric current corresponding to image data to drive the light emitting unit to emit light having a value substantially equal to the predetermined target light quantity.

13. The method according to claim 7, wherein the sensing the quantity of light of the light emitting unit comprises:
sensing a quantity of light emitted by the light emitting unit using a resistor having a fixed value.

14. A light quantity control system usable with an image forming apparatus, comprising:
a light emitting unit to emit to emit light corresponding to image data;
a sensing unit to sense the light emitted from the light emitting unit; and
a controller to adjust the image data according to the sensed value of light such that the light emitting unit emits light according to the adjusted image data.

15. The light quantity control system of claim 14, further comprising:
a calculating device to calculate a difference between the sensed light and a target light value,
wherein the controller adjusts the image data according to the calculated difference.

16. The light quantity control system of claim 14, further comprising:
an error reduction unit to reduce a difference in value between a value of light detected from the light emitting unit and an image data target light value such that the reduced difference in value is substantially equal to zero, and having an output equal to the reduced difference in value,
wherein the controller adjusts the image data according to the reduced difference.

17. The light quantity control system of claim 14, wherein:
the image data comprises first color image data and second color image data;
the controller adjusts the first color image data and the second color image data; and
the light emitting unit emits first light and second light according to the adjusted first color image data and the adjusted second color image data, respectively.

18. The light quantity control system of claim 14, wherein:
the light emitting unit comprises:
a laser diode to emit light corresponding to the image data;
a first photodiode to sense the emitted light; and
a feedback loop to control the light emitting unit to emit light according to the sensed light of the first photodiode;
the sensing unit comprises:
a second photodiode to sense the emitted light of the light emitting unit; and
the controller controls the light emitting unit to emit the light according to the sensed light of the second photodiode of the sensing unit.

19. A method to control a light quantity control system usable with an image forming apparatus, the method comprising:
emitting light from a light emitting unit corresponding to image data;
sensing the emitted light of the light emitting unit in a sensing unit; and
controlling the image data to adjust the image data according to the sensed light such that the light emitting unit emits light according to the adjusted image data.

20. The method of claim 19, the method further comprising:
calculating a difference between the sensed light and a target light value,
wherein the controlling the image data includes adjusting the image data according to the calculated difference.

21. The method of claim 19, the method further comprising:
reducing a difference in value between a value of light detected from the light emitting unit and an image data target light value such that the reduced difference in value is substantially equal to zero, and providing an output signal equal to the reduced difference in value,
wherein the controlling the image data includes adjusting the image data according to the reduced difference.

22. The method of claim 19, wherein:
the image data comprises first color image data and second color image data;
the controlling the image data includes adjusting the first color image data and the second color image data; and
the emitting the light includes emitting first light and second light according to the adjusted first color image data and the adjusted second color image data, respectively.

23. The method of claim 19, wherein:
the light emitting unit comprises:
a laser diode to emit light corresponding to the image data;
a first photodiode to sense the emitted light; and
a feedback loop to control the light emitting unit to emit light according to the sensed light of the first photodiode;
the sensing unit comprises:
a second photodiode to sense the emitted light of the light emitting unit; and
the controlling of the image data includes controlling the light emitting unit to emit the light according to the sensed light of the second photodiode of the sensing unit.
